(19) United States
(12) Patent Application Publication
(10) Pub. No.: US 2026/0100350 A1
(43) Pub. Date: Apr. 9, 2026

(54) CATHODE MATERIAL FOR ZINC SECONDARY BATTERY INCLUDING TUNGSTEN OXIDE AND METHOD FOR PRODUCING THE SAME

(71) Applicant: MPS KOREA CO., LTD., Gyeonggi-Do (KR)

(72) Inventors: Ki Il Yang, Gyeonggi-Do (KR); Soon Hyung Cho, Gyeonggi-Do (KR)

(73) Assignee: MPS KOREA CO., LTD., Gyeonggi-Do (KR)

(21) Appl. No.: 18/961,729

(22) Filed: Nov. 27, 2024

(30) Foreign Application Priority Data
Oct. 7, 2024 (KR) 10-2024-0135735

(51) Int. Cl. H01M 4/36; C01G 41/02; H01M 4/02; H01M 4/24; H01M 4/48; H01M 4/583; H01M 10/24

(52) U.S. Cl. CPC H01M 4/362; C01G 41/02; H01M 4/24; H01M 4/48; H01M 4/583; H01M 10/24; C01P 2002/77; C01P 2006/40; H01M 2004/021; H01M 2004/028

(57) ABSTRACT

The present invention relates to a cathode material for a zinc secondary battery including a tungsten oxide, a vanadium oxide, and a carbonaceous material, and a method for producing the same.

### BACKGROUND

### 1. Technical Field

The present invention relates to a cathode material for a zinc secondary battery including a tungsten oxide, a vanadium oxide, and a carbonaceous material, and a method for producing the same.

### 2. Description of the Related Art

Secondary batteries are batteries that can be repeatedly charged and discharged. Lithium secondary batteries, which are representative secondary batteries, operate on the principle that lithium ions in a cathode active material move to an anode through an electrolyte and then intercalate into the layered structure of an anode active material, thereby charging a battery, and then the lithium ions intercalated in the layered structure of the anode active material return to the cathode as the battery is discharged during use.

Lithium secondary batteries are currently commercially available and are used as power sources for small devices such as mobile phones and laptop computers and for large devices such as hybrid or electric vehicles, and thus the demand therefor is expected to increase explosively.

However, composite metal oxides, which are mainly used as cathode active materials in lithium secondary batteries, contain rare metals such as lithium, and thus, there may be problems with the supply thereof and there is also a risk of fire due to the strong oxidation properties of lithium.

Accordingly, research has recently been conducted on sodium secondary batteries that use sodium, which is abundant and cheap, as a cathode active material. However, since sodium is also a metal that is highly oxidizable in the atmosphere, it can cause risks such as fire and thus is still problematic in terms of safety, even though the supply thereof may be sufficient.

Due to the advancement of various technologies for wearable electronic devices beyond flexible electronic devices that are recent development trend, the demand for secondary batteries that operate using highly safe materials without the risk of explosion is also increasing.

Zinc secondary batteries, which have been proposed as an alternative to lithium or sodium secondary batteries and actively studied recently, have advantages over other secondary batteries in that they are highly safe against explosion by using aqueous electrolytes, are environmentally friendly, have low toxicity, and are cost-effective compared to other alkali metal secondary batteries. Problems currently emerging in the research of zinc secondary batteries include the formation of dendrites by zinc ions during continuous electrochemical reactions, the capacity reduction of MnO₂-based cathode active materials, and manganese dissolution.

### SUMMARY

An object of the present invention is to provide a cathode material for a zinc secondary battery, which is more abundant than lithium and does not have problems such as explosion, and a method for producing the same.

The objects of the present invention are not limited to the object mentioned above. The objects of the present invention will become more apparent from the following description and will be achieved by the means described in the claims and/or combinations thereof.

A cathode material for a zinc secondary battery according to one embodiment of the present invention may include a vanadium oxide, a tungsten oxide, and a carbonaceous material.

The vanadium oxide may include at least one selected from the group consisting of V₂O₅, VO₂, and a combination thereof.

The vanadium oxide may have an octahedral structure.

The tungsten oxide may include WO₃.

The tungsten oxide may have an octahedral structure.

The cathode material may include the tungsten oxide in an amount of 1 to 10 parts by weight based on 100 parts by weight of the vanadium oxide, and may include the carbonaceous material in an amount of 10 to 50 parts by weight based on 100 parts by weight of the sum of the vanadium oxide and the tungsten oxide.

The cathode material may have an average particle diameter of 1 nm to 100 nm.

A method for producing a cathode material for a zinc secondary battery according to one embodiment of the present invention may include: preparing a solution containing a vanadium oxide, a tungsten oxide, and a polymer; spinning (electrospinning) the solution to obtain fibers; heat-treating the fibers; and pulverizing the heat-treated fibers.

Preparing the solution may include: preparing a starting material containing vanadium oxide and tungsten oxide precursors dissolved therein; obtaining powder including the vanadium oxide and the tungsten oxide by heat-treating the starting material; and obtaining a solution containing the powder and polymer dissolved therein.

According to the present invention, it is possible to provide a cathode material for a zinc secondary battery, which is more abundant than lithium and has no problems such as explosion, and a method for producing the same.

According to the present invention, it is possible to provide a zinc secondary battery having excellent charge/discharge characteristics.

The effects of the present invention are not limited to the effects mentioned above. It should be understood that the effects of the present invention include all effects that may be inferred from the following description.

### BRIEF DESCRIPTION OF THE DRAWINGS

FIG. 1 illustrates a zinc secondary battery according to the present invention;

FIG. 2 illustrates crystal structures of vanadium oxide in a cathode material according to the present invention;

FIG. 3 illustrates the layered structure of tungsten oxide in a cathode material according to the present invention;

FIG. 4 shows the Raman spectral peaks of VO₂;

FIG. 5 shows the Raman spectral peaks of VO(acac)₂;

FIG. 6 shows the Raman spectrum of a fiber before heat treatment; and

FIG. 7 shows the Raman spectrum of the fiber before heat treatment.

### DETAILED DESCRIPTION

The above objects, other objects, features and advantages of the present invention will be better understood from the following description of preferred embodiments taken in conjunction with the accompanying drawings. The present invention may, however, be embodied in different forms and should not be construed as limited to the embodiments set forth herein. Rather, the embodiments disclosed herein are provided so that this disclosure will be thorough and complete, and will fully convey the scope of the present invention to those skilled in the art.

Unless otherwise noted, like reference numbers refer to like elements throughout the accompanying drawings and the detailed description. In the accompanying drawings, the dimensions of structures are exaggerated for clarity of illustration.

As used herein, the terms “include,” “comprise,” “including,” or “comprising,” “have”, “having”, etc. are intended to denote the presence of the stated characteristics, numbers, steps, operations, components, parts, or combinations thereof, but do not exclude the probability of presence or addition of one or more other characteristics, numbers, steps, operations, components, parts, or combinations thereof. In addition, when a part, such as a layer, film, region, plate, or the like, is referred to as being “on” or “above” another part, it not only refers to a case where the part is directly above the other part, but also a case where a third part exists therebetween. Conversely, when a part, such as a layer, film, region, plate, or the like, is referred to as being “below” another part, it not only refers to a case where the part is directly below the other part, but also a case where a third part exists therebetween.

Since all numbers, values and/or expressions referring to quantities of components, reaction conditions, polymer compositions, and mixtures used in the present specification are subject to various uncertainties of measurement encountered in obtaining such values, unless otherwise indicated, all are to be understood as modified in all instances by the term “about”. Where a numerical range is disclosed herein, such a range is continuous, inclusive of both the minimum and maximum values of the range as well as every value between such minimum and maximum values, unless otherwise indicated. Still further, where such a range refers to integers, every integer between the minimum and maximum values of such a range is included, unless otherwise indicated.

FIG. 1 illustrates a zinc secondary battery according to the present invention.

The zinc secondary battery may include: a cathode 10; an anode 20; a separator 30 between the cathode 10 and the anode 20; and an electrolyte (not shown) impregnated in at least one of the cathode 10, the anode 20, and the separator 30.

The cathode 10 may include a cathode material, a conductive material, a binder, etc.

The cathode material may include a vanadium oxide, a tungsten oxide, and a carbonaceous material. The vanadium oxide and the tungsten oxide may form a complex. The complex is a concept distinct from a mixture, and the vanadium oxide and the tungsten oxide may exhibit enhanced synergistic effects while maintaining their own unique properties. The vanadium oxide and the tungsten oxide are strongly chemically or structurally bonded to each other, and thus they may not be easily separated from each other by physical methods. Specifically, the vanadium oxide is a promising cathode material due to its high theoretical specific capacity and rich crystal structure, but it has problems such as low electronic conductivity and its dissolution in the electrolyte, which reduces the capacity. The present invention is characterized by adding a carbonaceous material to compensate for the low ion conductivity of the vanadium oxide and forming a complex with the tungsten oxide to ensure the intercalation and deintercalation of Zn ions.

Meanwhile, divalent zinc ions have disadvantages in that desolvation increases depending on the charge density of the metal cation, thus hindering diffusion through the electrodes, and the high charge density of intercalated ions leads to greater coulombic interaction with the surrounding lattice and thus retards the solid-state diffusion process. Solutions to these problems include methods of promoting the intercalation of multivalent cations by using nanosized host materials to increase the contact area between the electrode and the electrolyte and shorten the diffusion length or by using host structures with wide layer or channel diffusion pathways.

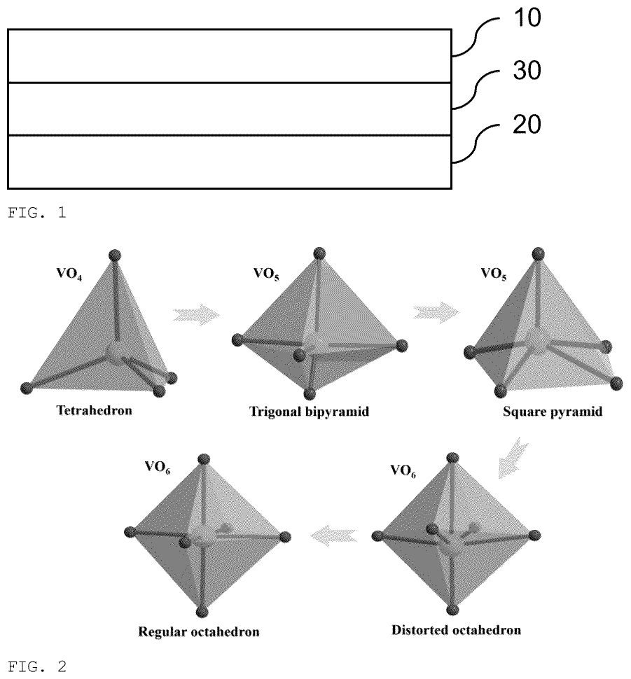

FIG. 2 illustrates crystal structures of vanadium oxide in the cathode material according to the present invention. Referring to FIG. 2, the oxidation state of the vanadium oxide is from +5 to +3, and the vanadium oxide is a promising cathode material due to its high theoretical specific capacity, rich crystal structure, etc. The vanadium oxide consists of VO₆ octahedra sharing corners, and V₂O₅ has a lattice spacing of about 4.4 Å, which is large enough to allow intercalation and deintercalation of atoms such as Li⁺ (0.76 Å), Na⁺ (1.02 Å), K⁺ (1.38 Å), and Zn²⁺ (0.74 Å).

The vanadium oxide may include at least one selected from the group consisting of V₂O₅, VO₂, and a combination thereof.

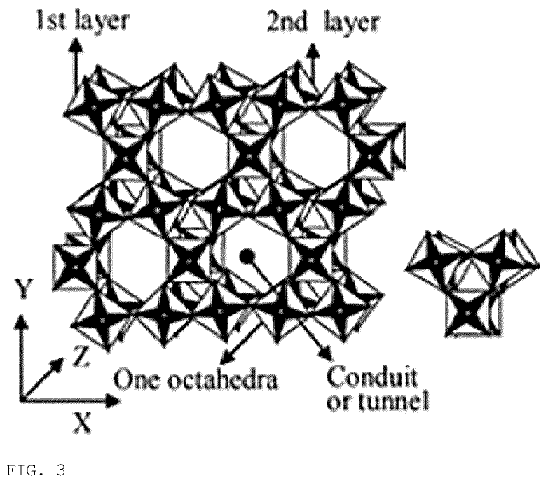

The tungsten oxide in the cathode material consists of WO₆ octahedra, which have W—O bonds formed around tungsten (W) atoms, and is generally called a perovskite structure. The simplest form is WO₃ or LiWO₃. Originally, tungsten (W) atoms are located at each corner, and oxygen atoms are located at the unit cell edges, but when viewed from the perspective of the tungsten (W) atoms, the oxygen particles are located at the four corners around the tungsten particle. In this case, the spacing between oxygen atoms is about 0.3 nm, and the center is an empty space. The empty space is filled with other atoms to form a symmetrical relationship. FIG. 3 illustrates the layered structure of the tungsten oxide in the cathode material according to the present invention. When multiple layers of the tungsten oxide are stacked, a tunnel is formed and small ions may be intercalated and deintercalated by external force. In addition, it seems that some oxygen-deficient WO3-x structures can be filled with metal ions other than oxygen ions. The above-mentioned case is for an ideal case. If general synthesis is performed, WO₃ [symbol] nH₂O is generally produced. If the tungsten oxide is synthesized hydrothermally, the space may become more distorted and the width of the empty space may further increase. If WO₃ having this structure is synthesized hydrothermally while introducing a different metal or is synthesized forcibly, the different metal will further distort the empty space, making intercalation and deintercalation easier. The tungsten oxide may include WO₃.

The carbonaceous material may serve to increase the electronic conductivity of the cathode material. The type of the carbonaceous material is not particularly limited, and may include, for example, pulverized carbon fiber.

The cathode material may include the tungsten oxide in an amount of 1 to 10 parts by weight based on 100 parts by weight of the vanadium oxide. When the content of the tungsten oxide falls within the above numerical range, it is possible to achieve the effect of complexing the vanadium oxide and the tungsten oxide with each other.

The cathode material may include the carbonaceous material in an amount of 10 to 50 parts by weight based on 100 parts by weight of the sum of the vanadium oxide and the tungsten oxide. When the content of the carbonaceous material falls within the above numerical range, the carbonaceous material may sufficiently compensate for the low electronic conductivity of the vanadium oxide.

The cathode material may have an average particle diameter of 1 nm to 100 nm. Here, the average particle diameter may mean a median diameter (D50) and may represent a particle size at a point where the cumulative distribution corresponds to 50% in a particle size distribution curve. The average particle diameter may be measured by laser diffraction, dynamic light scattering, image analysis, etc.

The conductive material is a component of the cathode 10, which is distinct from the carbonaceous material and may be responsible for the overall electronic conduction in the cathode 10.

The conductive material may be a general conductive material used in the art, and the type thereof is not particularly limited. Examples of the conductive material include carbon black, acetylene black, graphene, graphite, etc.

Since the cathode material according to the present invention has high electronic conductivity, the content of the conductive material in the cathode 10 may be reduced. The content of the conductive material is not particularly limited, and may be, for example, about 0.1 wt % to 5 wt % based on the total weight of the cathode 10.

The binder may be a component that binds the components of the cathode 10. The binder may be a general binder used in the art, and the type thereof is not particularly limited. Examples of the binder include polyvinylidene fluoride (PVDF), a vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinyl pyrrolidone, tetrafluoroethylene, polyethylene, polypropylene, an ethylene-propylene-diene polymer (EPDM), sulfonated-EPDM, styrene-butadiene rubber (SBR), fluorinated rubber, or various copolymers thereof.

The content of the binder is not particularly limited and may be, for example, about 0.1 wt % to 3 wt % based on the total weight of the cathode 10. When the content of the binder falls within the above numerical range, it is possible to achieve excellent adhesion while minimizing an increase in resistance within the cathode 10.

The anode 20 may include zinc, zinc oxide, a zinc alloy, a zinc compound, or any combination thereof. Zinc may be included in any form selected from zinc metal, a zinc compound, and a zinc alloy, as long as it has appropriate electrochemical activity for the anode. Preferred examples of the anode material include zinc oxide, zinc metal, calcium zincate, etc., but a mixture of zinc metal and zinc oxide is more preferred.

The separator 30 separates the cathode 10 and the anode 20 from each other and provides a channel for zinc ions to move between the two electrodes, and any separator that is generally used as a separator in a secondary battery may be used without particular limitation. Specifically, the separator that is used in the present invention may be a porous polymer film, for example, a porous polymer film made of a polyolefin-based polymer such as an ethylene homopolymer, a propylene homopolymer, an ethylene/butene copolymer, an ethylene/hexene copolymer, or an ethylene/methacrylate copolymer, or a laminated structure of two or more layers including the porous polymer film. In addition, a conventional porous non-woven web, such as a non-woven fabric made of high-melting point glass fiber, polyethylene terephthalate fiber, or the like, may also be used. Further, in order to ensure heat resistance or mechanical strength, a coated separator containing a ceramic component or a polymer material may be used, which may have a single-layer or multi-layer structure.

The electrolyte may include an organic liquid electrolyte, an inorganic liquid electrolyte, a solid polymer electrolyte, a gel-type polymer electrolyte, a solid inorganic electrolyte, a molten inorganic electrolyte, or the like, which may be used in a secondary battery.

The electrolyte may preferably include a liquid electrolyte including a metal salt and a solvent for dissolving the same. Examples of the metal salt include ZnSO₄, Zn(CF₃SO₃)₂, and the like. The solvent may include an aqueous solvent or an organic solvent.

The electrolyte is not limited thereto, and may include a polymer-type solid electrolyte prepared by impregnating a polymer with the liquid electrolyte, or a ceramic solid electrolyte. The polymer in the polymer-type solid electrolyte may include a polyethylene oxide-based polymer compound, a polymer compound including at least one of a polyorganosiloxane chain and a polyoxyalkylene chain, or the like.

A method for producing a cathode material for a zinc secondary battery according to a first embodiment of the present invention may include the steps of: preparing a solution containing a vanadium oxide, a tungsten oxide, and a polymer; spinning the solution to obtain fibers; heat-treating the fibers, and pulverizing the heat-treated fibers.

The step of preparing the solution may include the steps of: preparing a starting material containing vanadium oxide and tungsten oxide precursors dissolved therein; obtaining powder including the vanadium oxide and the tungsten oxide by heat-treating the starting material; and obtaining a solution containing the powder and polymer dissolved therein. The tungsten oxide precursor may include ammonium paratungstate ((NH₄)₁₀(H₂W₁₂O₄₂) [symbol] 4H₂O). The vanadium oxide and tungsten oxide precursors may be added in amounts appropriately adjusted depending on the contents of the vanadium oxide and the tungsten oxide in the desired cathode material.

When the starting material is heat-treated, the tungsten oxide precursor may be converted into the tungsten oxide which may be complexed with the vanadium oxide. The conditions for the heat treatment are not particularly limited, and the starting material may be heat-treated at about 150° C. to 250° C. for 12 to 36 hours. Additionally, the heat-treated material may be dried to obtain the powder.

The polymer may include polyacrylonitrile (PAN). The polymer is a precursor of the carbonaceous material, and may be converted into the carbonaceous material by being carbonized through heat treatment as described below.

Thereafter, the solution is spun to obtain fibers, and the fibers may be heat-treated. The method and conditions for the spinning are not particularly limited, and, for example, the solution may be electrospun. The conditions for the heat treatment are not particularly limited, and the heat treatment of the fibers may be performed at a temperature and for a time, which may carbonize the polymer without affecting the vanadium oxide and the tungsten oxide. The heat-treated fibers obtained as described above may be pulverized to obtain a cathode material having an average particle diameter of 1 nm to 100 nm.

A method for producing a cathode material for a zinc secondary battery according to a second embodiment of the present invention may include the steps of: preparing a solution containing a vanadium oxide, a tungsten oxide precursor, and a polymer; spinning the solution to obtain fibers; heat-treating the fibers; and pulverizing the heat-treated fibers.

The second embodiment may be different from the first embodiment in that the step of obtaining powder is omitted and the tungsten oxide precursor is converted into the tungsten oxide in the step of heat-treating the fibers. Since other contents are the same as those in the first embodiment, description thereof will be omitted.

Hereinafter, the present invention will be described in more detail by way of production examples and examples.

### Production Example 1: Production of WO₃

50 g of Na₂WO₄ [symbol] 2H₂O was dissolved in 100 ml of distilled water, and the solution was passed through a cation exchange resin to adsorb Na ions onto the cation exchange resin and obtain yellow WO₃. Then, ammonia water having an ammonia concentration of 25 wt % to 30 wt % was added thereto to obtain ammonium paratungstate, which was then dried to obtain ammonium paratungstate powder.

### Production Example 2: Production 1 of V₂O₅/WO₃/C Cathode Material

20 g of V₂O₅ powder and 27 g of oxalic acid were added to 200 ml of distilled water, and the solution was stirred in a stirrer at 200 rpm for 6 hours to completely dissolve the V₂O₅ powder. Then, 1 g (5 wt % based on the weight of V₂O₅) of the ammonium paratungstate of Production Example 1 was added thereto, and the mixture was stirred for about 2 hours to completely dissolve the V₂O₅ and the ammonium paratungstate. The resulting solution was placed in a Teflon-wrapped stainless steel tube, heat-treated at about 200° C. for about 24 hours, filtered, washed twice with alcohol and distilled water, and then dried at about 60° C. for about 24 hours to obtain V₂O₅/WO₃ powder.

The powder was mixed with polyacrylonitrile (PAN) at a mass ratio of 1:1, and dimethylformamide (DMF) was added thereto at a weight ratio of 2.5:1. Then, the mixture was stirred at 200 rpm at 70° C. for 4 hours to dissolve the powder and the PAN.

10 mL of the dissolved V₂O₅/WO₃/PAN was placed in a syringe and spun at a voltage of 15 kV and a spinning speed of 2.0 mL/hr onto a plate at a distance of 20 cm to obtain V₂O₅/WO₃/PAN nanofibers.

The fibers were heat-treated in air up to 550° C. at a heating rate of 5° C./min for 1 hour, and the heated-treated nanofibers were pulverized with a pulverizer to obtain a nano-sized V₂O₅/WO₃/C cathode material.

### Production Example 3: Production 2 of V₂O₅/WO₃/C Cathode Material

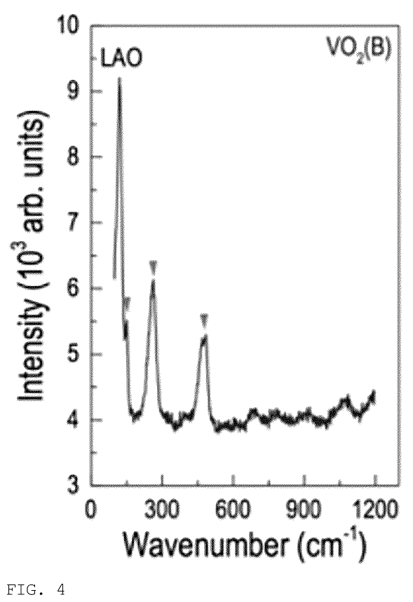

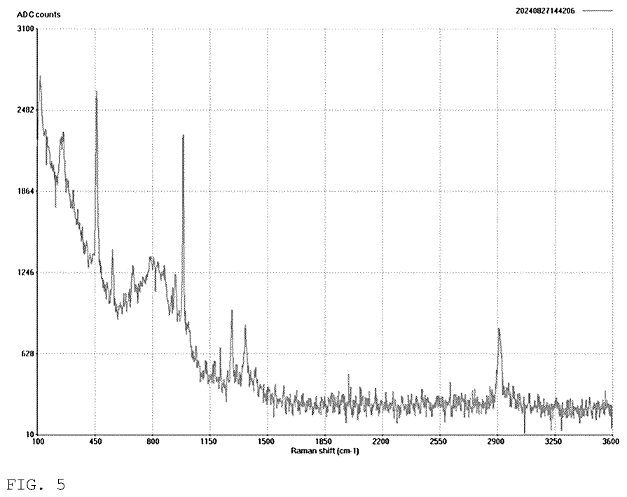

0.25 g (5 wt % based on the weight of VO(acac)₂) of ammonium paratungstate was added to 5 g of VO(acac)₂, and polyacrylonitrile (PAN) was added thereto at a mass ratio of 1:1. Then, dimethylformamide (DMF) was added thereto at a weight ratio of 2.5:1, and the mixture was stirred at 200 rpm at 70° C. for 4 hours to dissolve the VO(acac)₂, the ammonium paratungstate and the PAN. FIG. 4 shows the Raman spectral peaks of VO₂. FIG. 5 shows the Raman spectral peaks of VO(acac)₂.

The Raman spectrum in FIG. 4 shows peaks in the wavenumber range of 150 to 600 cm⁻¹, which are similar to those in FIG. 5.

10 mL of the dissolved VO₂/WO₃/PAN was placed in a syringe and spun at a voltage of 15 kV and a spinning speed of 2.0 mL/hr onto a plate at a distance of 20 cm to obtain VO₂/WO₃/PAN nanofibers.

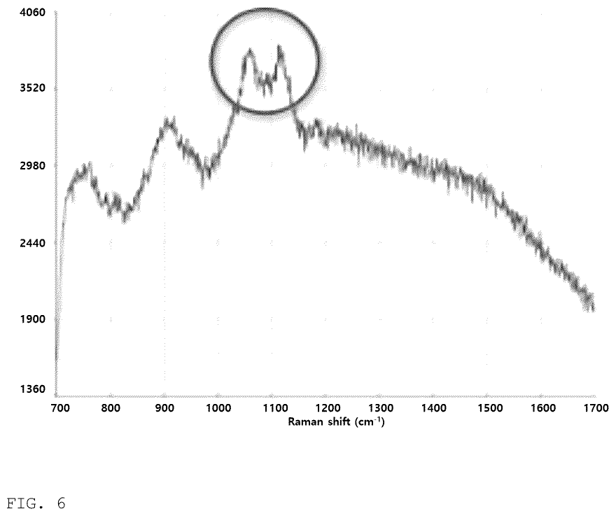

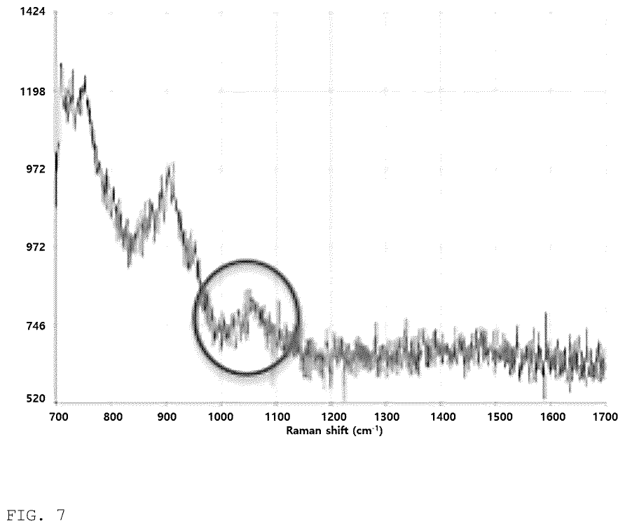

The fibers were heat-treated in air up to 550° C. at a heating rate of 5° C./min for 1 hour, and the heated-treated nanofibers were pulverized with a pulverizer to obtain a nano-sized VO₂/WO₃/C cathode material. FIG. 6 shows the Raman spectrum of the fiber before heat treatment. FIG. 7 shows the Raman spectrum of the fiber before heat treatment. Referring to FIG. 6, peaks indicated by the red circle appear at around 1100 cm⁻¹, and these peaks are typical peaks of carbon and appear to be peaks attributable to the carbon component present in the PAN added to VO(acac)₂. FIG. 7 also shows carbon peaks, even though the intensity of the peaks was weakened.

### Example: Fabrication of Zinc Ion Half-Cell Including Cathode Using WO₃

Since the V₂O₅/WO₃/C cathode material of Production Example 2 contains a carbonaceous material capable of conducting electrons, a small amount of a conductive material (Super P) may be added. Therefore, the cathode material, a binder (polyvinylidene fluoride) (PVDF), and a conductive material at a weight ratio of 8.5:0.5:1 were added to an organic solvent (N-methyl-2-pyrrolidone) (NMP), thereby preparing a slurry. A stainless steel foil current collector was coated with the slurry which was then dried under vacuum at 60° C. for 12 hours to form a cathode.

A zinc ion half-cell was fabricated as a coin cell using the cathode, a MoS₂-coated zinc metal plate as an anode, and an aqueous electrolyte solution containing Zn(CF₃SO₃)₂ as an electrolyte and water as a solvent.

While the present invention has been described with reference to the accompanying drawings, it will be understood by those skilled in the art to which the present invention pertains that the present invention may be embodied in other specific forms without departing from the technical spirit or essential characteristics of the present invention. Therefore, the embodiments described above are considered to be illustrative and not restrictive in all respects.

1. A cathode material for a zinc secondary battery comprising a vanadium oxide, a tungsten oxide, and a carbonaceous material.

2. The cathode material of claim 1, wherein the vanadium oxide comprises at least one selected from the group consisting of V₂O₅, VO₂, and a combination thereof.

3. The cathode material of claim 1, wherein the vanadium oxide has an octahedral structure.

4. The cathode material of claim 1, wherein the tungsten oxide comprises WO₃.

5. The cathode material of claim 1, wherein the tungsten oxide has an octahedral structure.

6. The cathode material of claim 1, wherein the tungsten oxide is comprised in an amount of 1 to 10 parts by weight based on 100 parts by weight of the vanadium oxide, and the carbonaceous material is comprised in an amount of 10 to 50 parts by weight based on 100 parts by weight of the sum of the vanadium oxide and the tungsten oxide.

7. The cathode material of claim 1, wherein the cathode material has an average particle diameter of 1 nm to 100 nm.

8. A zinc secondary battery comprising: a cathode; an anode; a separator between the cathode and the anode; and an electrolyte impregnated in the separator, wherein the cathode comprises the cathode material of claim 1.

9. A method for producing a cathode material for a zinc secondary battery comprising a vanadium oxide, a tungsten oxide, and a carbonaceous material, the method comprising:
preparing a solution containing the vanadium oxide, the tungsten oxide, and a polymer;
spinning the solution to obtain fibers;
heat-treating the fibers; and
pulverizing the heat-treated fibers.

10. The method of claim 9, wherein preparing the solution comprises:
preparing a starting material containing vanadium oxide and tungsten oxide precursors dissolved therein;
obtaining powder comprising the vanadium oxide and the tungsten oxide by heat-treating the starting material; and
obtaining a solution containing the powder and polymer dissolved therein.

11. The method of claim 9, wherein the vanadium oxide comprises at least one selected from the group consisting of V₂O₅, VO₂, and a combination thereof.

12. The method of claim 9, wherein the vanadium oxide has an octahedral structure.

13. The method of claim 10, wherein the tungsten oxide precursor comprises ammonium paratungstate ((NH₄)₁₀(H₂W₁₂O₄₂) [symbol] 4H₂O).

14. The method of claim 9, wherein the tungsten oxide comprises WO₃.

15. The method of claim 9, wherein the tungsten oxide has an octahedral structure.

16. The method of claim 9, wherein the tungsten oxide is comprised in an amount of 1 to 10 parts by weight based on 100 parts by weight of the vanadium oxide, and the carbonaceous material is comprised in an amount of 10 to 50 parts by weight based on 100 parts by weight of the sum of the vanadium oxide and the tungsten oxide.

17. The method of claim 9, wherein the cathode material has an average particle diameter of 1 nm to 100 nm.
